(19) United States
(12) Patent Application Publication
(10) Pub. No.: US 2014/0368473 A1
(43) Pub. Date: Dec. 18, 2014

(54) METHOD OF SELECTING TOUCH INPUT SOURCE AND ELECTRONIC DEVICE USING THE SAME

(71) Applicant: Acer Incorporated, New Taipei City (TW)

(72) Inventors: Yu-Min Chang, New Taipei City (TW); Hsing-Lung Chung, New Taipei City (TW)

(73) Assignee: Acer Incorporated, New Taipei City (TW)

(21) Appl. No.: 13/965,197

(22) Filed: Aug. 13, 2013

(30) Foreign Application Priority Data
Jun. 13, 2013 (TW) 102120929

(51) Int. Cl. G06F 3/0354; G06F 3/041

(52) U.S. Cl. CPC G06F 3/03545; G06F 3/0412
USPC 345/179

(57) ABSTRACT

A method of selecting a touch input source and an electronic device using the same are provided. The present method includes determining whether the electronic device detects an activating signal sent from a stylus. The method also includes defining the stylus as an input signal source of the electronic device when the activating signal is detected by the electronic device. The method further includes defining an electric conductive material and/or a finger as the input signal source of the electronic device when the activating signal is not detected.

### CROSS-REFERENCE TO RELATED APPLICATION

This application claims the priority benefit of Taiwan application serial no. 102120929, filed on Jun. 13, 2013. The entirety of the above-mentioned patent application is hereby incorporated by reference herein and made a part of this specification.

### BACKGROUND OF THE INVENTION

1. Field of the Invention

The invention relates to an application of a touch sensing technology, and more particularly to a method of selecting a touch input source and an electronic device using the same.

2. Description of Related Art

With improvement of touch technology, touch elements have been widely used by electronic products as input device. For instance, due to restriction in device size for meeting demands of portability, touch screens have been utilized by mobile electronic devices nowadays as input and output device for saving space required for physical keyboard while increasing screen size thereof.

When a user operates a mobile electronic device having a touch screen, the touch screen is probably mistakenly touched due to manners of holding the device and gestures of inputting, such that the mobile electronic device may response incorrectly. For instance, when the user utilizes a tablet computer and a stylus for drawing, in order to improve comfort for inputting, a lateral portion of a palm is probably leaned against on the tablet computer. However, a position where the lateral portion of the palm contacting the touch screen is not of an input that the user intended to perform, yet the tablet computer will still draw unnecessary dots or lines on said position in response to a touch sensed by the touch screen. Predictably, interference caused by being mistakenly touched brings negative effects to use perception.

### SUMMARY OF THE INVENTION

Accordingly, the invention is directed to a method of selecting a touch input source and an electronic device using the same, and capable of effectively distinguishing whether a user utilizes a stylus or a finger to perform operations on a touch panel, such that a touch input source may be selected properly, so to avoid unwanted operations performed by the electronic device.

The method of selecting the touch input source of the invention is suitable for an electronic device having a touch panel, and the method includes determining whether the electronic device detects an activating signal sent from the stylus. The method also includes defining the stylus as an input signal source of the electronic device when the activating signal is detected by the electronic device. The method further includes defining an electric conductive material and/or a finger as the input signal source of the electronic device when the activating signal is not detected by the electronic device.

An electronic device of the invention includes a touch panel, a communication unit and a processing unit. The processing unit is coupled to the touch panel and the communication unit. The processing unit determines whether the communication unit receives the activating signal sent from the stylus. The processing unit defines the stylus as an input signal source of the electronic device when the activating signal is detected. The processing unit defines an electric conductive material and/or a finger as the input signal source of the electronic device when the activating signal is not detected.

Based on above, the method of selecting the touch input source and the electronic device using the same in the invention may affectively determine whether the user performs operations with the stylus. When the user performs the operations with the stylus, the touch data generated by touching the touch panel with the electric conductive material and/or the finger may be filtered out and only the touch data retrieved from the stylus is processed. As a result, when the user holds the stylus for inputting, the unwanted operations performed by the electronic device due to the touch panel being mistakenly touched by the palm may be avoided.

To make the above features and advantages of the disclosure more comprehensible, several embodiments accompanied with drawings are described in detail as follows.

### BRIEF DESCRIPTION OF THE DRAWINGS

FIG. 1 is a block diagram illustrating an electronic device according to an embodiment of the invention.

FIG. 2 is a flowchart of selecting a touch input source according to an embodiment of the invention.

FIG. 3A is a schematic diagram illustrating a user holding a stylus according to an embodiment of the invention.

FIG. 3B is a schematic diagram illustrating a stylus according to an embodiment of the invention.

FIG. 4 is a flowchart of defining the stylus as the input signal source according to an embodiment of the invention.

FIG. 5 is a flowchart of defining the electric conductive material and/or the finger as the input signal source according to an embodiment of the invention.

### DESCRIPTION OF THE EMBODIMENTS

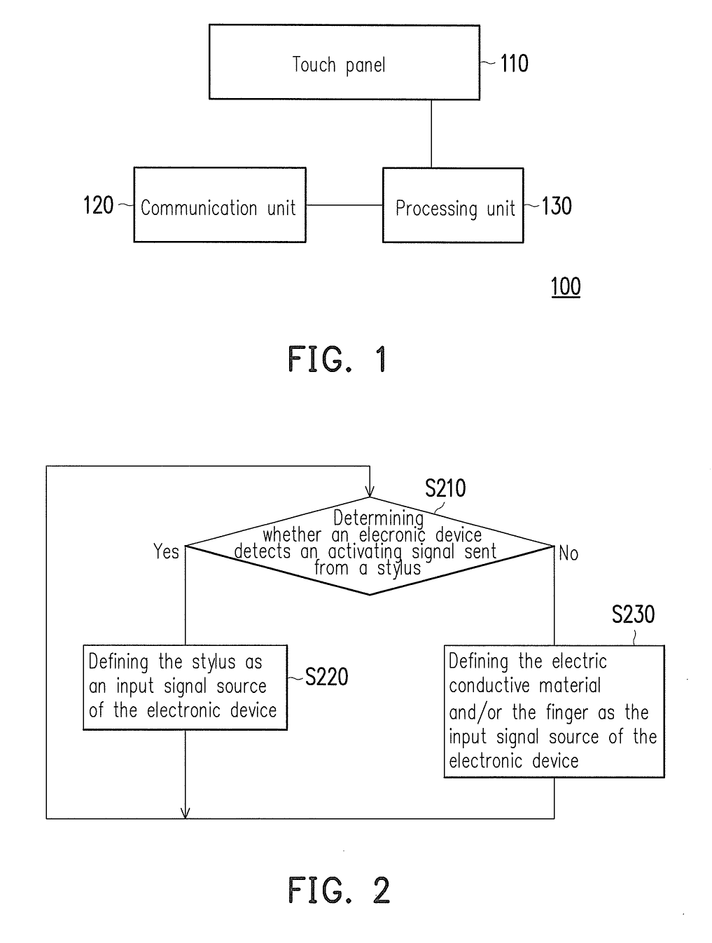

FIG. 1 is a block diagram illustrating an electronic device according to an embodiment of the invention. Referring to FIG. 1, an electronic device 100 includes a touch panel 110, a communication unit 120 and a processing unit 130. The electronic device 100 may be a cellular phone, a smart phone, a personal digital assistant, a tablet computer, a game console or an e-book, but the type of the above is not particularly limited in the invention.

The touch panel 110 includes a plurality of capacitive touch sensing elements. The touch panel 110 is capable of detecting a touch performed by input tools such as a finger, an electric conductive material or a stylus, and serving as an input interface of the electronic device 100. In other embodiments, a touch screen may be constituted by combining the touch panel 110 with a display panel (not illustrated) of the electronic device 100, and served as an input and output interface of the electronic device 100.

The communication unit 120 is, for example, a radio communication module including a transmitter and a receiver for signal transmission with other devices.

The processing unit 130 is coupled to the touch panel 110 and the communication unit 120. The processing unit 130 may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements. The processing unit 130 is mainly responsible for controlling operations of the electronic device 100. More particularly, it is configured to identify whether the user performs operations on the touch panel 110 by using the finger or the electric conductive material, or performs the operations on the touch panel 110 by holding and using the stylus. Subsequently, a touch input source may be properly selected according to a result of said identification, so as to control the electronic device 100 to response to the operations performed by the user correctly.

FIG. 2 is a flowchart of selecting a touch input source according to an embodiment of the invention. The operations of the electronic device 100 are described below with reference of FIG. 1 and FIG. 2.

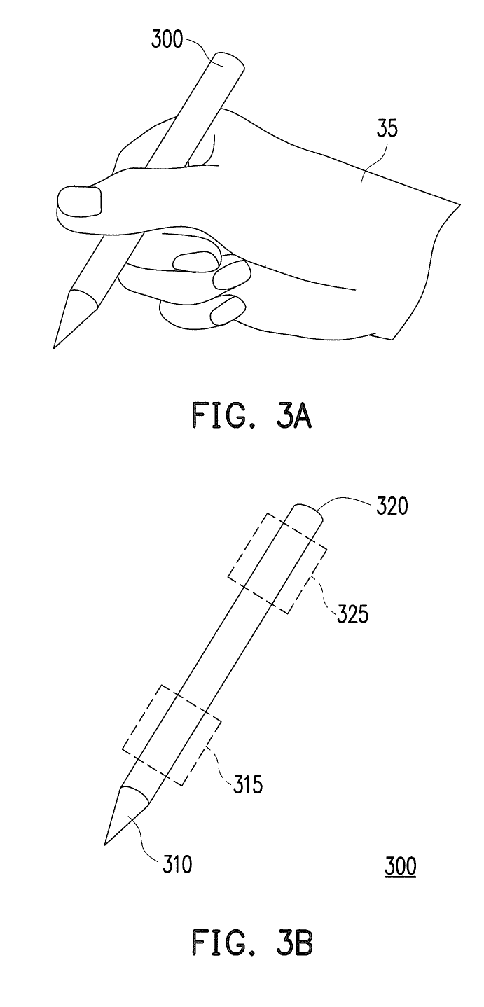

When the electronic device 100 is powered on, the processing unit 130 determines whether an activating signal sent from the stylus is detected by the electronic device 100, as shown in step S210. That is, the processing unit 130 determines whether the communication unit 120 receives the activating signal sent from the stylus. The stylus of the present embodiment is an active stylus including a pen body configured with at least one sensing element, and the sensing element may be a button, a charge-variation sensing element (e.g., an indium tin oxide (ITO)) or a motion sensing element (e.g., an acceleration sensor, a vibration sensor or a gyroscope). Types of the sensing elements are not particularly limited to the above, and any elements capable of detecting whether the stylus is held and used by the user falls within the scope of the invention. The stylus sends the activating signal when the at least one sensing element configured within the stylus detects a human touch, and the activating signal is, for example, a carrier signal. FIG. 3A is a schematic diagram of operations performed by a hand 35 holding a stylus 300 for most of users. Although different users may hold pens slightly different from each other, a possibility that two ends of the pen contacting the hand of the user is generally high. Therefore, as shown in FIG. 3B, in the present embodiment, one or more than one sensing element is configured proximate to an area 315 of a pen head 310 of the stylus 300 and/or an area 325 of a pen tail 320 of the stylus 300. Nevertheless, the areas 315 and 325 configured on the sensing elements are merely examples cited for description, and the invention is not limited thereto.

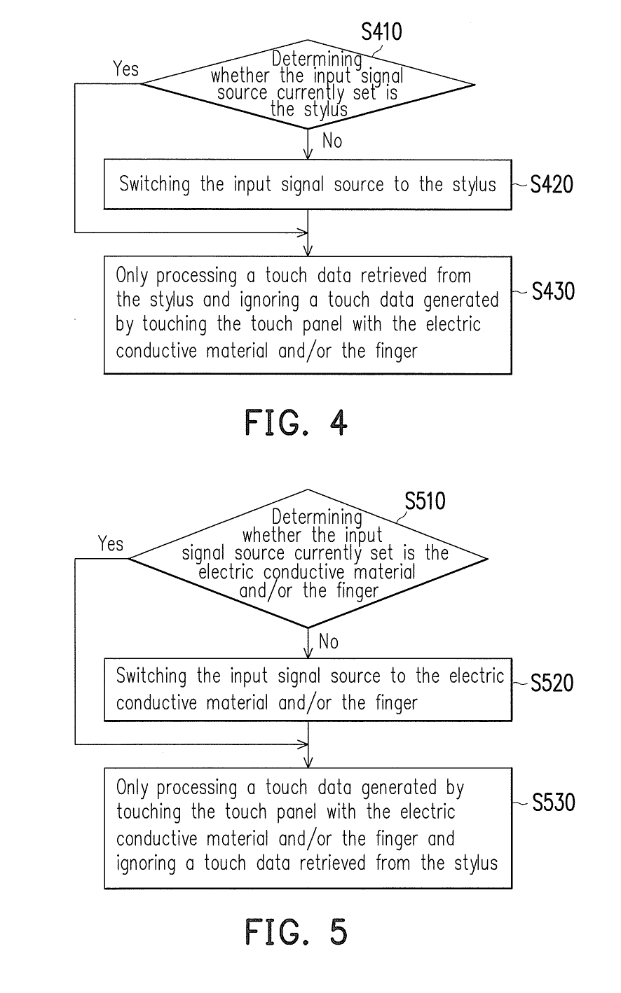

If a result of the determination in step S210 is yes, this indicates that there is the stylus held by the user approaching to the touch panel 110. In this case, the processing unit 130 defines the stylus as an input signal source of the electronic device 100, as shown in step S220. FIG. 4 is a flowchart of defining the stylus as the input signal source of the electronic device 100 according to an embodiment of the invention. The following description refers to FIG. 4.

In step S410, the processing unit 130 determines whether the input signal source currently set is the stylus, and the input signal source is, for example, a system parameter recorded in a storage unit (not illustrated) of the electronic devices 100.

If a result of the determination in step S410 is no, the processing unit 130 switches the input signal source to the stylus, as shown in step S420. If the result of the determination in step S410 is yes, the processing unit 130 does not perform any switching operation to the input signal source. Subsequently, the processing unit 130 only processes a touch data retrieved from the stylus and ignores a touch data generated by touching the touch panel 110 with the electric conductive material and/or the finger, as shown in step S430. In other words, once the stylus is defined as the input signal source of the electronic device 100, only the information sent from the stylus is deemed as a valid input, and any other touches on the touch panel 110 caused by a human body (e.g., the finger, the palm and so on) or the electric conductive material are deemed as an invalid input.

Referring back to step S210 depicted in FIG. 2. If the result of the determination in step S210 is no, the processing unit 130 defines the electric conductive material and/or the finger as the input signal source of the electronic device 100, as shown in step S230. Detailed description of said step is provided below with reference of FIG. 5.

As shown in step S510, the processing unit 130 first determines whether the input signal source currently set is the electric conductive material and/or the finger. If yes, the processing unit 130 does not change settings of the input signal source. If no, the processing unit 130 switches the input signal source to the electric conductive material and/or the finger, as shown in step S520. Subsequently, the processing unit 130 only processes the touch data generated by touching the touch panel 110 with the electric conductive material and/or the finger and ignores the touch data retrieved from the stylus, as shown in step S530. That is, the electronic device 100 only responses properly to touching of the touch panel 110 with the human body (e.g., the finger) or the electric conductive material.

In the present embodiment, the touch data selected by the processing unit 130 is temporarily stored in a data temporary storage unit (not illustrated) of the electronic device 100, so that an operating system of the electronic device 100 may access the touch data later and response correspondingly to the touch data.

As long as the electronic device 100 is not powered off, the processing unit 130 may continue to repeat each step depicted in FIG. 2, so that only the touch data retrieved from the stylus is selected when the stylus is used by the user, so as to avoid an circumstance in which the touch panel 100 is mistakenly touched by the hand. For instance, when the user activates a drawing software installed in the electronic device 100 and performs a drawing operation with the stylus, the communication unit 120 receives the activating signal sent from the stylus, such that the processing unit 130 may filter out the touch data retrieved from the touch panel 110 and only performs subsequent processes to the touch data retrieved from the stylus. As a result, noises generated by touching the touch panel 110 with the hand of the user may be avoided, so as to ensure that the electronic device 100 only displays contents drawn by utilizing the stylus. Moreover, in case that the user has added multiple application shortcuts on a home screen of the electronic device 100, when the user intends to select one of the application shortcuts with the stylus, the processing unit 130 may also accurately determine that only the operations from the stylus belongs to what the user really intended to operate, so that the touch data generated by touching the touch panel 110 with the hand may be filtered out, so as to avoid activating of unnecessary application program. Besides, when the processing unit 130 determines that the stylus is not used by the user, a proper process may also be performed to the touch data generated by touching the touch panel 100 with the electric conductive material and/or the finger.

In light of above, the invention provides a method of selecting a touch input source and an electronic device using the same, in which a decision is made based on detection of whether the activating signal is sent from the stylus, so as to select either the stylus or otherwise the electric conductive material and/or the finger, as a valid input device. As a result, it is ensured that the electronic device may response correctly to the operations performed by the user, so as to enhance operating accuracy of the electronic device.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method of selecting a touch input source for an electronic device having a touch panel, comprising:
determining whether the electronic device detects an activating signal sent from a stylus;
defining the stylus as an input signal source of the electronic device when the activating signal is detected; and
defining an electric conductive material and/or a finger as the input signal source of the electronic device when the activating signal is not detected.

2. The method of claim 1, wherein the stylus is configured with at least one sensing element, and the activating signal is sent from the stylus when a human touch is detected by at least one among the at least one sensing element.

3. The method of claim 2, wherein each of the at least one sensing element is a button, a charge-variation sensing element or a motion sensing element.

4. The method of claim 1, wherein the step of defining the stylus as the input signal source of the electronic device when the activating signal is detected, further comprising:
determining whether the input signal source currently set to the electronic device is the stylus; and
if not, switching the input signal source to the stylus, so that the electronic device only processes a touch data retrieved from the stylus and ignores a touch data generated by touching the touch panel with the electric conductive material and/or the finger.

5. The method of claim 1, wherein the step of defining the electric conductive material and/or the finger as the input signal source of the electronic device when the activating signal is not detected, further comprising:
determining whether the input signal source currently set to the electronic device is the electric conductive material and/or the finger; and
if not, switching the input signal source to the electric conductive material and/or the finger, so that the electronic device only processes a touch data generated by touching the touch panel with the electric conductive material and/or the finger and ignores a touch data retrieved from the stylus.

6. An electronic device, comprising:
a touch panel;
a communication unit; and
a processing unit coupled to the touch panel and the communication unit, wherein the processing unit determines whether the communication unit receives an activating signal sent from a stylus,
the processing unit defines the stylus as an input signal source of the electronic device when the activating signal is detected,
the processing unit defines an electric conductive material and/or a finger as the input signal source of the electronic device when the activating signal is not detected.

7. The electronic device of claim 6, wherein the stylus is configured with at least one sensing element, and the activating signal is sent from the stylus when a human touch is detected by at least one among the at least one sensing element.

8. The electronic device of claim 7, wherein each of the at least one sensing element is a button, a charge-variation sensing element or a motion sensing element.

9. The electronic device of claim 6, wherein the processing unit defines the stylus as the input signal source of the electronic device by determining whether the input signal source currently set to the electronic device is the stylus,
if not, the processing unit switches the input signal source to the stylus, and only processes a touch data retrieved from the stylus and ignores a touch data generated by touching the touch panel with the electric conductive material and/or the finger.

10. The electronic device of claim 6, wherein the processing unit defines the electric conductive material and/or the finger as the input signal source of the electronic device by determining whether the input signal source currently set to the electronic device is the electric conductive material and/or the finger,
if not, the processing unit switches the input signal source to the electric conductive material and/or the finger, and only processes a touch data generated by touching the touch panel with the electric conductive material and/or the finger and ignores a touch data retrieved from the stylus.
